(19) United States
(12) Patent Application Publication
(10) Pub. No.: US 2010/0110287 A1
(43) Pub. Date: May 6, 2010

(54) METHOD AND APPARATUS FOR MODELING FILM GRAIN NOISE

(75) Inventors: Yu LIU, Hong Kong (HK); Ka Man CHENG, Hong Kong (HK); Yan HUO, Shenzhen Guangdong (CN); Lu WANG, Shenzhen Guangdong (CN)

Correspondence Address: FAY SHARPE LLP, 1228 Euclid Avenue, 5th Floor, The Halle Building, Cleveland, OH, 44115, US

(73) Assignee: HONG KONG APPLIED SCIENCE AND TECHNOLOGY RESEARCH INSTITUTE CO. LTD., Hong Kong (HK)

(21) Appl. No.: 12/262,639

(22) Filed: Oct. 31, 2008

(51) Int. Cl. H04N 7/00

(52) U.S. Cl. 348/484; 348/E07.001

(57) ABSTRACT

This invention relates to a method and system for modeling film grain noise. The film grain noise as modeled is applied to a video signal. Both the signal-dependent aspect 430 and the correlation aspect 440 of the film grain noise are taken into consideration, resulting in a more realistic modeling of film grain noise. Furthermore, the efficiency and the flexibility for modeling film grain noise are improved by use of the method and system according to this invention.

### RELATED APPLICATION

There are no related applications.

### TECHNICAL FIELD

The claimed invention relates generally to signal processing. More particularly, the claimed invention relates to noise modeling for video signals. In further particular, the claimed invention relates to modeling of film grain noise for video signals and application of film grain noise as modeled to video signals.

### BACKGROUND OF THE INVENTION

Film is a medium for taking still pictures and motion pictures. For example, the movie industry makes movies on films and individuals take home movies, albeit with declining frequency owing to the rise of home video cameras. The use of film leads to the existence of film grain noise in displayed during playback and this film grain noise has become a signature of using film for moving pictures. Visually, audience is capable of not only recognizing film by the existence of film grain noise but also differentiating moving pictures by film in reality from other post-filming editing or artificial effects such as those film effects, computer graphics, animations and synthetic scenes.

Nevertheless, the film grain noise is lost from time to time, for example, it is filtered by video processing methods such as compression and encoding/decoding. Moreover, digital cameras are often widely used and people make their video on memory rather than film so that no film grain noise exists in digital videos at all. Viewing a video with no film grain noise, people have the feeling that despite the clarity the image presented appears to be artificial. Therefore, in order to preserve the high fidelity of video, people desires to add the film grain noise back to video.

In order to restore the film grain noise in a video image, a modeling of film grain noise is desirable.

### SUMMARY OF THE INVENTION

It is an object of the claimed invention to model film grain noise. The film grain noise includes characteristics such as signal dependency, power and pattern of grain noise. These characteristics are aspects which are useful for modeling. Apart from film grain noise, the claimed invention is further be used to model any noise with similar characteristics as disclosed in the present specification.

In term of signal dependency, one of the characteristics of film grain noise is that bright regions (high intensity regions) or dark regions (low intensity regions) of a frame in a film (also known as an image) usually have noise power characteristics different from that of mid-intensity regions. For example, as far as YCbCr color space is concerned, film grain noise has lower noise power in bright or dark regions than in mid-intensity regions in the Y component. But higher noise power exists in bright or dark regions than mid-intensity regions in the Cr and Cb components. For RGB color space, lower noise power exists in bright or dark regions than in mid-intensity regions in each of R, G, B components. Therefore, it is a further object of the claimed invention to model film grain noise with signal dependency.

It is a further object of the claimed invention to improve the efficiency of modeling film grain noise by providing a method for modeling the signal-dependent characteristics without performing any segmentation for each frame in order to capture the noise characteristics for different regions in a given frame.

It is a further object of the claimed invention to improve the efficiency of modeling film grain noise by reducing the noise parameters to be estimated, for example, the same parameters for modeling film grain noise are used for frames of same scene rather than having the parameters estimated for every single frame.

It is a further object of the claimed invention to provide the flexibility in modeling film grain noise by providing a number of noise functions to be used. The noise functions in use and the noise function parameters is selected frame by frame to adapt for noise characteristics in each frame.

It is a further object of the claimed invention to model film grain noise with different kinds of correlation, for example, spatial correlation, cross-color correlation.

It is a further object of the claimed invention to further improve the efficiency by reducing the number of auto-regression model parameters for computation of noise modeling and thus the number of auto-regression model parameters to be transmitted from encoder to decoder is less.

It is a further object of the claimed invention to improve the efficiency of modeling film grain noise because only noise function identifier, parameters of noise function and auto-regression model parameters need to be transmitted from encoder to decoder. As a result, payload is thus reduced significantly.

It is a further object of the claimed invention to provide a method which models the film grain noise and add the film grain noise back to video.

It is a further object of the claimed invention to provide a system which models the film grain noise and adds the film grain noise back to video.

Other aspects of the claimed invention are also disclosed.

### BRIEF DESCRIPTION OF THE DRAWINGS

These and other objects, aspects and embodiments of this claimed invention will be described hereinafter in more details with reference to the following drawings, in which:

FIG. 1 shows a flow diagram of a method for modeling film grain noise.

FIG. 2 shows the graphical representations of various noise functions.

FIG. 3 shows a flow diagram of a method for estimating signal-dependent noise parameters.

FIG. 4 shows a flow diagram of a further embodiment of the method for modeling film grain noise.

FIG. 5 shows a flow diagram of a further embodiment of the method for modeling film grain noise.

FIG. 6 shows a flow diagram of a method of applying film grain noise to a signal.

FIG. 7 shows a schematic block diagram of a system for applying film grain noise to a signal.

FIG. 8 shows a flow diagram of a method of introducing film grain noise to a digital video signal.

FIG. 9A shows a sample image without film grain noise before the application of film grain noise.

FIG. 9B shows a sample image with film grain noise after the application of film grain noise.

### DETAILED DESCRIPTION OF THE INVENTION

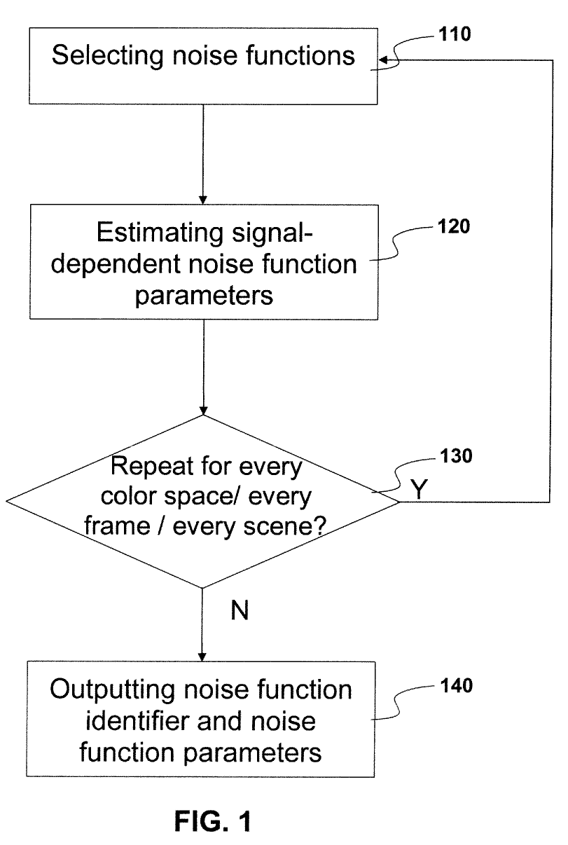

FIG. 1 shows a flow diagram of a method for modeling film grain noise. Since film grain noise is signal-dependent, it is modeled by the following equation in one embodiment:

y=x+ƒ(x)^{γ}·n (1)

where x is the noise-free signal, n is a stationary, zero-mean random noise independent of x, and y is the observed noisy signal. The ƒ(x)^{γ}·n represents the signal-dependent noise tern, and γ is the noise exponent value. As an example, γ is set to be 0≦γ≦1. The value of γ is related to the film materials. Noise function ƒ(x) is selected in selecting noise function step 110 and noise function parameters are estimated in estimating step 120. In a further embodiment, different noise functions are selected for different frames in a video by performing selecting noise function step 110 for every single frame in order to capture the difference in noise characteristics from frame to frame. The noise function parameters corresponding to each noise function are also estimated in estimating step 120 for every single frame. The selecting noise function step 110 and the estimating step 120 are reiterated in repeating step 130. In yet another embodiment, in order to improve the efficiency, same noise function and same corresponding noise function parameters are used for frames of same scene by repeating selecting noise function step 110 and estimating step 120 for every scene through repeating step 130 only. In one embodiment, selection of noise function in selecting noise function step 110 and estimation of noise function parameters in estimating step 120 are performed for every color space of a frame through repeating step 130. Each noise function is represented by a noise function identifier so that a noise function identifier and corresponding noise function parameters either for each color space, each frame or each scene are output in outputting step 140.

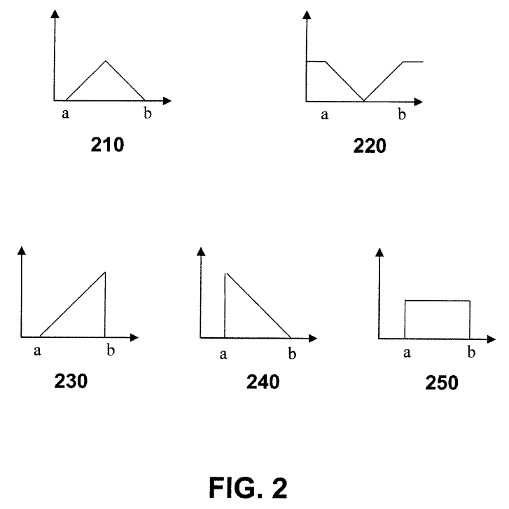

FIG. 2 shows a number of embodiments for noise functions. Various noise functions are used and those noise functions described as follows are just for exemplary and illustrative purposes. The graphical representations of noise functions 210, 220, 230, 240, 250 in FIG. 2 are represented in the following equations:

$$For first noise function 210 , \\ f ( x ) = \{ \begin{matrix}0 , & x < a \\ x - a , & a \leq x \leq ( a + b ) / 2 \\ b - x , & ( a + b ) / 2 \leq x \leq b \\ 0 , & x > b\end{matrix} \\ For second noise function 220 , \\ f ( x ) = \{ \begin{matrix}\frac{b - a}{2} , & x < a \\ \frac{a + b}{2} - x & a \leq x \leq ( a + b ) / 2 \\ x - \frac{a + b}{2} , & ( a + b ) / 2 \leq x \leq \\ \frac{b - a}{2} , & x > b\end{matrix} \\ For third noise function 230 , \\ f ( x ) = \{ \begin{matrix}0 , & x < a \\ x - a , & a \leq x \leq b \\ 0 , & x > b\end{matrix} \\ For fourth noise function 240 , \\ f ( x ) = \{ \begin{matrix}0 , & x < a \\ b - x , & a \leq x \leq b \\ 0 , & x > b\end{matrix} \\ For fifth noise function 250 , \\ f ( x ) = \{ \begin{matrix}0 , & x < a \\ 1 , & a \leq x \leq b \\ 0 , & x > b\end{matrix}$$

Since, at the different regions, the film grain noise has different noise characteristics, appropriate noise models in the equation (2) is available to be used to model the signal-dependent noise during the film grain noise generation by selecting different forms of noise function ƒ(x). For example, if ƒ(x) is selected to be the third noise function 230, then classical signal-dependent noise model of y=x+x^{γ}·ε is adopted, where ε is a Gaussian noise If ƒ(x) is selected to be the fifth noise function 250, then additive noise model of y=x+ε is adopted. In addition, when the third noise function 230 is selected, the multiplication noise model y=x+x·ε is achieved with the noise exponent value γ=1. The first noise function 210 and the second noise function 220 are used to capture the film grain noise in bright or dark regions, which have lower noise power in bright or dark regions than in mid-intensity for the Y component, but have higher noise power in bright or dark regions than in mid-intensity regions for the Cr and Cb components.

As one of the embodiments, the noise functions in use are identified by different identifiers, for example, the first noise function 210 is identified by an identifier. In this illustrative example, the identifier is A. Therefore, if the method for modeling film grain noise is implemented in a distant device, an identifier is provided to the distant device to select which noise function to use for generating the film grain noise as long as this distant device stores various noise functions. Noise function parameters for noise functions 210, 220, 230, 240, 250 such as parameter a are further determined. In one embodiment, the noise function parameter a is chosen to be 16 and the noise function parameter b is chosen to be 255−a which, in this case, is equal to 239. The parameters of the noise function are provided to a device where film grain noise is modeled.

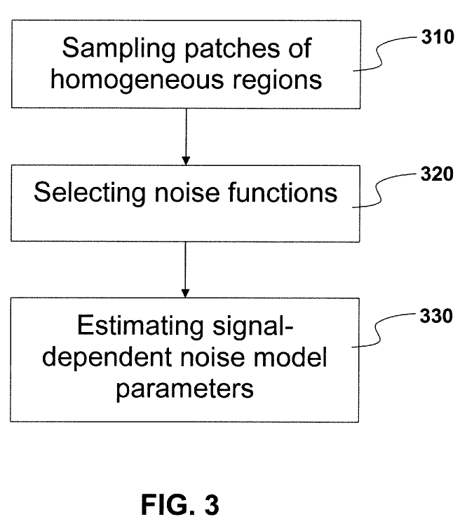

FIG. 3 shows a flow chart of a method for estimating signal-dependent noise model parameters. Patches of homogeneous regions are detected and extracted in sampling step 310. In one embodiment, those patches of homogeneous regions are detected by comparing signal characteristics such as intensity across different regions in an image or different regions across different frames in a video sequence. If the correlation of any regions is high, for example over a predetermined threshold, then these regions are extracted.

Once the noise functions are selected in selecting step 320 by determining noise function identifier and noise function parameters as previously described, the signal-dependent noise model parameters are estimated in estimating step 330, namely, the noise exponent value γ and the variance σₙ² of the random noise n is determined. The local variance of the observed signal y is expressed as:

σ_{y}²=E[(y−μ_{y})²]=E[(x+ƒ(x)^{γ}·n−μ_{y})²] (2)

where μ_{y} is the local mean of y, which equals to that of x in the homogeneous regions: μ_{y}=μₓ. The equation (2) is calculated and then becomes:

$$\begin{matrix}{σ}_{y}^{2} = E [ {( x + {f ( x )}^{γ} \cdot n - {μ}_{y} )}^{2} ] \\ = {σ}_{x}^{2} \{ 1 + γ ( 2 γ - 1 ) {E [ f ( x ) ]}^{2 γ - 2} {σ}_{n}^{2} \} + {E [ f ( x ) ]}^{2 γ} {σ}_{n}^{2}\end{matrix} \qquad ( 3 )$$

If some of patches are identified on the noisy signal as homogeneous regions, then σₓ²≈0 and equation (3) is written as

σ_{y}²=E[ƒ(x)]^{2γ}·σₙ² (4)

where the variance of y for these homogeneous regions is taken as the local variance σ_{y}², and E[ƒ(x)] is the mean value of ƒ(x).

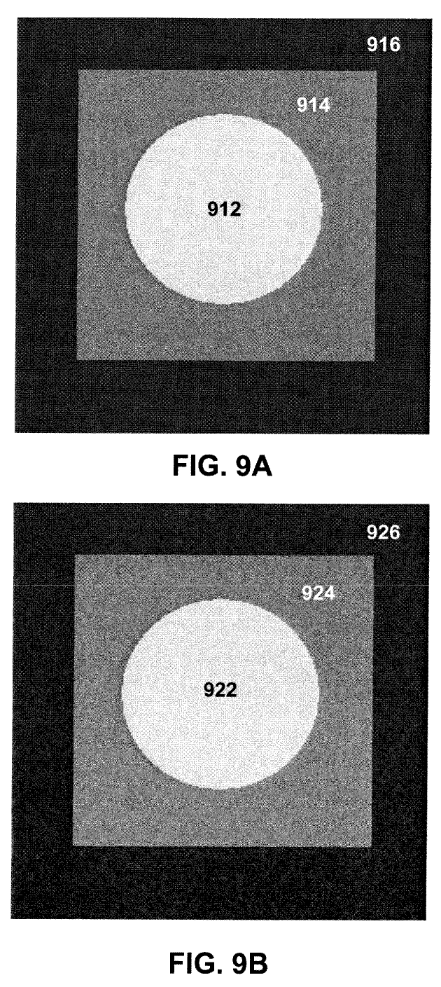

Therefore, in order to estimate the unknown noise model parameters γ and σₙ², patches of homogeneous regions need to be identified in a frame and even across different frames in a video sequence. As an example, different homogeneous regions are identifiable in FIG. 9A as represented by an inner circle 912, an inner square 914 and an outer square 916.

In one embodiment, either of two different methods is used for estimating signal-dependent noise as follows:

I. An Offline Method

This method is used offline instead of on-the-fly. After patches of homogeneous regions are extracted in the sampling step 310, σ_{y}² and E[ƒ(x)] in the equation (4) are calculated statistically for each patch of homogeneous region. After the statistical data information about σ_{y}² and E[ƒ(x)] is obtained, a curve fit method is applied to estimate the unknown noise model parameters γ and σₙ². In one embodiment, the curve fit method by using least square error estimation is used. The offline method avoids the local minimum problem and achieves the global optimal solution for the whole image or the video sequence.

II. An Online Method

This method is used online and directly estimates in real time the unknown noise model parameters by using M pairs of patches (i^{th} patch, j^{th} patch) as follows:

$$\tilde{γ} = \frac{1}{( M - 1 ) !} {\sum }_{i = 1}^{M - 1} {\sum }_{j = i}^{M} \frac{log {σ}_{i} - log {σ}_{j}}{log {μ}_{i} - log {μ}_{j}} \qquad ( 5 )$$

where M is is larger or equal to three in one embodiment, σᵢ and μᵢ is the i^{th} patch's σ_{y} and E[ƒ(x)], σⱼ and μⱼ is the j^{th} patch's σ_{y} and E[ƒ(x)]. The values resulting from different pairs of patches are different from one another, therefore, a consistent estimate of the true gamma is found by, for example, averaging the estimated values of all the possible pairs. Once the gamma γ has been estimated by means of the equation (5), the σₙ² is calculated by

$${σ}_{n}^{2} = \frac{1}{M} {\sum }_{i} \frac{{σ}_{y , i}^{2}}{{E [ f ( x ) ]}_{i}^{2 γ}} \qquad ( 6 )$$

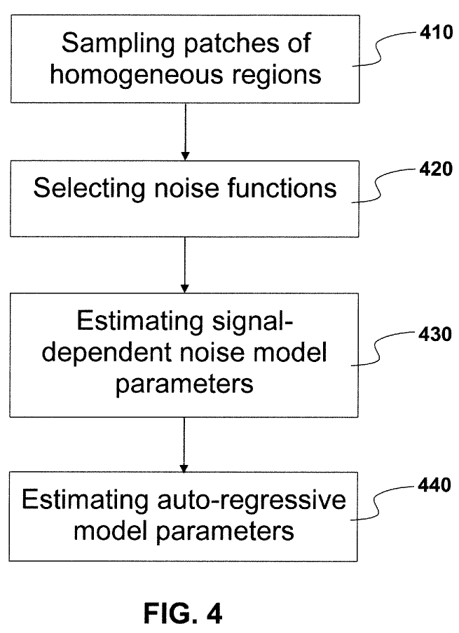

FIG. 4 shows a flow diagram of a further embodiment of the method for modeling film grain noise. Film grain noise may contain different kinds of correlation, for example, spatial correlation, or cross-color correlation. With the incorporation of the above description, patches of homogeneous regions are selected in sampling step 410. Then noise functions for signal-dependent noise of film grain noise are selected in selecting step 420. The signal-dependent noise model parameters are estimated in first estimating step 430. In second estimating step 440 for auto-regression model parameters, the following exemplary auto-regression model is considered to model the pattern of film grain noise:

$$n ( i , j , c ) = {\sum }_{{i}^{′}} {\sum }_{{j}^{′}} {\sum }_{{c}^{′}} {a}_{{i}^{′} , {j}^{′} , {c}^{′}} n ( i - {i}^{′} , j - {j}^{′} , c - {c}^{′} ) \qquad ( 7 )$$

which is a 3D auto-regression model which includes the 2D spatial correlation (i, j) and 1D cross-color correlation (c). In one embodiment of the equation (7), the film grain noise is assumed to have the same characteristics over the whole image so that a small number of coefficients are used for the auto-regression model. In yet another embodiment, according to the empirical results, values of (i′,j′, c′) are predetermined to be (1,0,0), (0,1,0), (1,1,0), (−1,1,0), (2,0,0), (0,2,0), (2,2,0), (−2,2,0), (0,0,1), which results in a causal filter in the raster scanning order and increases the efficiency for noise generation. In a further embodiment of this 3D auto-regression model, auto-regression model parameters are symmetric under the assumption of the directional symmetry of film grain noise, meaning that a_{1,0,0}=a_{0,1,0}, a_{1,1,0}=a_{-1,1,0}, a_{2,0,0}=a_{0,2,0} and a_{2,2,0}=a_{-2,2,0}. Thus the number of auto-regression model parameters is further reduced.

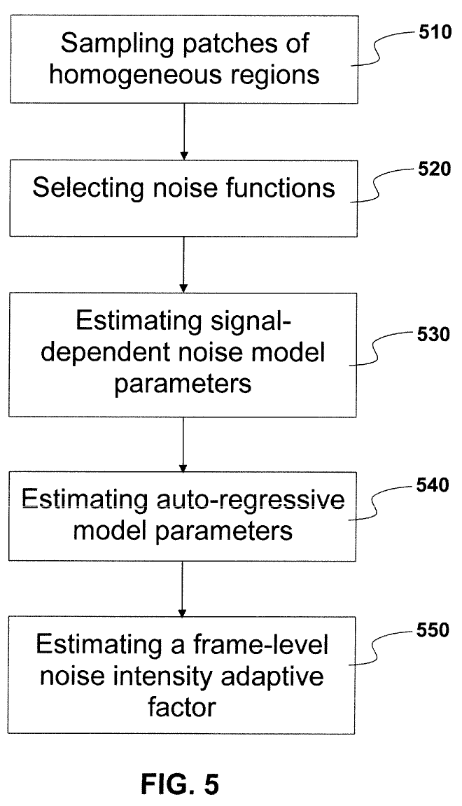

FIG. 5 shows a flow diagram of a further embodiment of the method for modeling film grain noise. With the incorporation of the above description, patches of homogeneous regions are selected in sampling step 510. Then noise functions for signal-dependent noise of film grain noise are selected in selecting step 520. The signal-dependent noise model parameters are estimated in first estimating step 530. The auto-regression model parameters are estimated in second estimating step 540. In one embodiment, the signal-dependent noise model parameters are estimated per scene in a video sequence rather than per frame in the first estimating step 530 to save costs such as computation time. Frames of the same scene are detected by comparing the correlation among these frames and if they are highly correlated, then they are regarded as belonging to the same scene. Nevertheless, in order to capture the slight difference of the signal-dependent noise among each frame of the same scene, scaling is applied to the signal-dependent noise by multiplying a frame-level noise intensity adaptive factor k in one embodiment. The frame-level noise intensity adaptive factor k is estimated in third estimating step 550 according to the following equation:

$$k = \frac{{σ}_{y , frame}^{γ}}{{E [ f ( x ) ]}^{2 γ} \cdot {σ}_{n , scene}^{2}} \qquad ( 8 )$$

As a result, the signal-dependent characteristics and the correlation characteristics of the film grain noise are captured in the following equation for generating the film grain noise and n(i,j,c) is also known as signal-dependent auto-regression noise:

$$n ( i , j , c ) = {\sum }_{{i}^{′}} {\sum }_{{j}^{′}} {\sum }_{{c}^{′}} {a}_{{i}^{′} , {j}^{′} , {c}^{′}} n ( i - {i}^{′} , j - {j}^{′} , c - {c}^{′} ) + k \cdot {f ( x )}^{γ} \cdot n \qquad ( 9 )$$

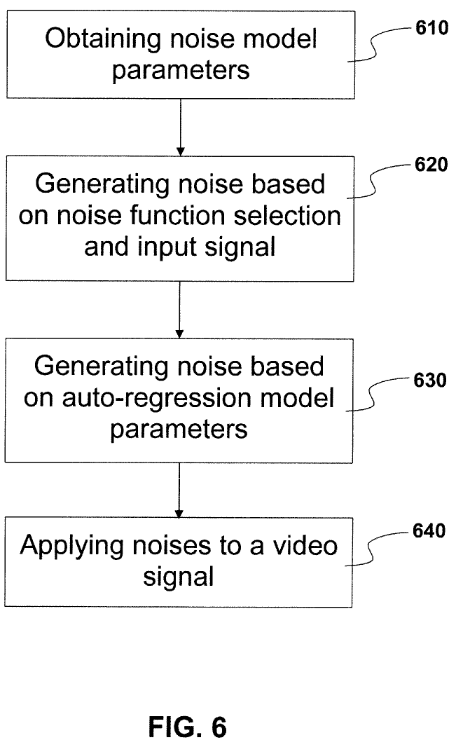

FIG. 6 shows a flow diagram of a method of applying film grain noise to a video signal. As illustrated above, film grain noise is made of a signal-dependent component and a correlation component modeled by auto-regression as in the equation (9). As long as the noise model parameters are obtained in obtaining step 610, for example, according to preset values or the results from the above estimation methods. The signal-dependent component k·ƒ(x)^{γ}·n is generated in first generating step 620 based on the noise function selection and the input video signal. The correlation component

$${\sum }_{{i}^{′}} {\sum }_{{j}^{′}} {\sum }_{{c}^{′}} {a}_{{i}^{′} , {j}^{′} , {c}^{′}} n ( i - {i}^{′} , j - {j}^{′} , c - {c}^{′} )$$

is generated in second generating step 630 based on the input video signal. According to the equation (9), the two components are then combined to apply the film grain noise to the output video signal in applying step 640.

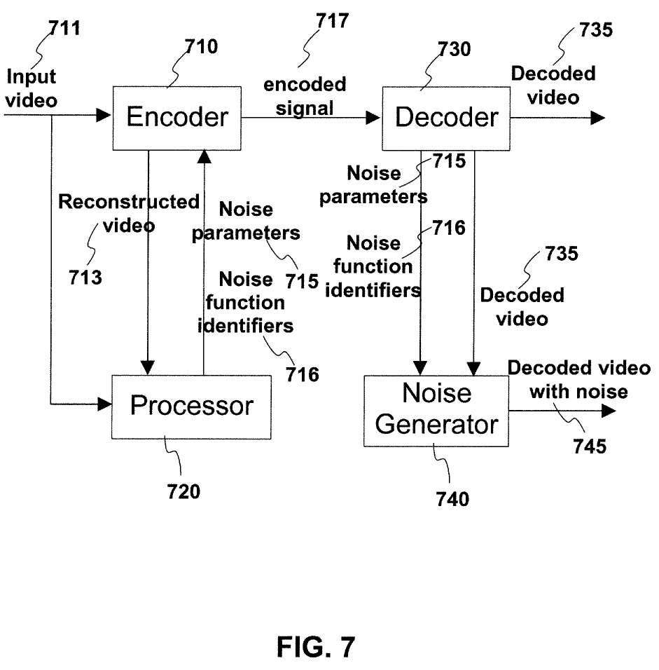

FIG. 7 shows a schematic block diagram of a system for applying film grain noise to a signal. The system comprises a first video processing apparatus at transmitting side and a second video processing apparatus at receiving side.

At the transmitting side, the first video processing apparatus comprises an encoder 710 and a processor 720. An input video 711 is fed into the encoder 710 for encoding to generate an encoded video 717. The encoder 710 is capable of decoding the encoded video 717 to provide a reconstructed video 713. The reconstructed video 713 is sent to the processor 720 together with the input video 711 to model film grain noise according to the equation (9) in one embodiment. What the processor 720 performs is the method of modeling film grain noise as described above. The unknown parameters in the equation (9) are known as noise parameters 715 while the function ƒ(x) in the equation (9) is known as noise function 716. Appropriate noise functions 716 are selected and represented as noise function identifiers 716. How the noise functions are selected and how the noise function parameters 715 are determined are disclosed as above. The processor 720 estimates noise parameters 715 according to the signal-dependent noise model and the auto-regression model as disclosed above. The processor 720 outputs noise function identifiers 716 and noise parameters 715 to the encoder 710 and the encoder 710 encode input video 711 with noise function identifiers 716 and noise function parameters 715 into encoded signal 717.

At the receiving side, the second video processing apparatus comprises a decoder 730 and a noise generator 740. After receiving encoded signal from the encoder 710, the decoder 730 decodes encoded signal 717 to output a decoded video 735 without film grain noise, noise parameters 715 and noise function identifiers 716. In the meantime, the decoder 730 also provides the decoded video 735, the noise function identifiers and the noise model parameters 715 to the noise generator 740. The noise generator 740 generates the film grain noise according to the equation (9) and applies the film grain noise to the decoded video 735 to output a decoded video 735 with noise 745.

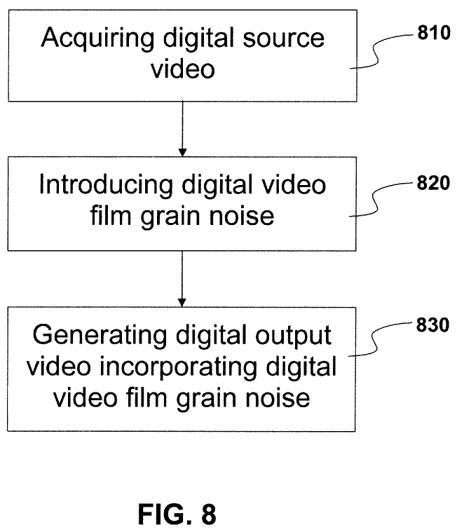

In one embodiment, a method of modeling film grain noise as previously described can be implemented as a method of introducing film grain noise to digital video signal. FIG. 8 shows a flow diagram of a method of introducing film grain noise to digital video signal. Digital source video is acquired in acquiring step 810. Film grain noise is introduced to digital source video in introducing step 820 and film grain noise as introduced is generated according to the method of modeling film grain noise as mentioned above. Digital output video with film grain noise incorporated is output in outputting step 830.

FIG. 9A shows a sample image without film grain noise before the application of film grain noise. This is an example of a frame in digital source video to be acquired in acquiring step 810 in FIG. 8. Three homogenous regions exist in the image and they are identified to be an inner circle 912, an inner square 914 and an outer square 916. FIG. 9B shows a sample image with film grain noise after the application of film grain noise. This is an example of a frame in digital output video to be output in outputting step 830 in FIG. 8. It is shown that film grain noise in regions with low intensity such as outer square 926 is visually less significant while for those regions with mid-level intensity such as inner circle 922 and inner square 924, film grain noise is visually more significant.

The description of preferred embodiments of this claimed invention are not exhaustive and any update or modifications to them are obvious to those skilled in the art, and therefore reference is made to the appending claims for determining the scope of this claimed invention.

### INDUSTRIAL APPLICABILITY

The disclosed methods and devices have industrial applicability in video signal processing. Furthermore, the claimed invention is used for film grain noise generation in video codec, such as AVS (Audio Video Coding Standard) and any future multimedia standards.

We claim:

1. A method of introducing digital video film grain noise comprising:
acquiring digital source video;
introducing digital video film grain noise into digital source video; and
generating digital output video incorporating said digital video film grain noise.

2. The method of introducing a digital video film grain noise as claimed in claim 1 further comprising:
selecting one or more noise functions after acquiring digital source video; and
estimating one or more signal-dependent noise model parameters.

3. The method of introducing a digital video film grain noise as claimed in claim 2, wherein:
performing selection of noise functions for every single frame.

4. The method of introducing a digital video film grain noise as claimed in claim 2, wherein:
performing selection of noise functions for every color space.

5. The method of introducing a digital video film grain noise as claimed in claim 2, wherein:
said one or more noise functions are represented by noise function identifiers.

6. The method of introducing a digital video film grain noise as claimed in claim 2 further comprising:
sampling three or more patches of homogeneous region after selecting one or more noise functions; and
computing said one or more signal-dependent noise model parameters by an offline method.

7. The noise modeling method as claimed in claim 2, further comprising:
sampling three or more patches of homogeneous region after selecting one or more noise functions; and
computing said one or more signal-dependent noise model parameters by an online method.

8. The method of introducing a digital video film grain noise as claimed in claim 2, wherein:
said one or more signal-dependent noise model parameters are identical for every frame with same scene.

9. The method of introducing a digital video film grain noise as claimed in claim 10 further comprising:
selecting a frame-level noise intensity adaptive factor for every frame after estimating said one or more signal-dependent noise model parameters; and
scaling said one or more noise functions by a frame-level noise intensity adaptive factor.

10. The method of introducing a digital video film grain noise as claimed in claim 1 further comprising:
obtaining one or more auto-regression model parameters.

11. The method of introducing a digital video film grain noise as claimed in claim 12, wherein:
said one or more auto-regression model parameters are symmetric and identical to each other.

12. The method of introducing a digital video film grain noise as claimed in claim 2 further comprising:
generating signal-dependent noise according to said one or more signal-dependent noise model parameters; and
generating signal-dependent auto-regression noise according to said one or more auto-regression model parameters based on said signal-dependent noise.

13. The method of introducing a digital video film grain noise as claimed in claim 13 further comprising:
applying said signal-dependent auto-regression noise to digital video signal.

14. A video processing apparatus, comprising:
a processor configured to model film grain noise by a plurality of noise functions; and
an encoder configured to encode video with a plurality of outputs from said processor.

15. The video processing apparatus as claimed in claim 14, wherein:
said processor outputs a plurality noise function identifiers to represent said plurality of noise functions.

16. The video processing apparatus as claimed in claim 14, wherein:
said processor estimates a plurality of noise parameters to model a signal-dependent component of said film grain noise.

17. The video processing apparatus as claimed in claim 14, wherein:
said processor estimates a plurality of noise parameters to model a correlation component of said film grain noise.

18. A video processing apparatus, comprising:
a decoder configured to decode signal to output video, a plurality of noise function identifiers and a plurality of noise parameters; and
a noise generator configured to generate film grain noise according to said plurality of noise function identifiers and said plurality of noise parameters.

19. The video processing apparatus as claimed in claim 18, wherein:
said noise generator selects a plurality of noise functions according to said plurality of noise function identifiers.

20. The video processing apparatus as claimed in claim 18, wherein:
said noise generator applies said film grain noise to said video.
